(19) United States
(12) Patent Application Publication
(10) Pub. No.: US 2023/0219987 A1
(43) Pub. Date: Jul. 13, 2023

(54) FLAMEPROOF ACRYLATE

(71) Applicant: RENOLIT SE, Worms (DE)

(72) Inventors: Dirk HEUKELBACH, Weiterstadt (DE); Martin RÖßLE, Mainz (DE); Manfred DÖRING, Wörth (DE); Michael CIESIELSKI, Merseburg (DE)

(21) Appl. No.: 18/009,705

(22) PCT Filed: Jun. 15, 2021
(86) PCT No.: PCT/EP2021/066038

§ 371 Date: Dec. 9, 2022

(30) Foreign Application Priority Data
Jun. 17, 2020 (DE) 10 2020 116 028.3

(51) Int. Cl. C07F 9/6571; C09D 143/02; C09D 5/18; C08F 230/02; C08L 43/02

(52) U.S. Cl. CPC C07F 9/657172; C09D 143/02; C09D 5/18; C08F 230/02; C08L 43/02; C08L 2201/10; C08L 2203/16

(57) ABSTRACT

Method for manufacturing oxaphosphaphenantrene oxide acrylate monomers by Phospha-Michael addition to acrylates, which comprises reacting oxaphosphaphenantrene oxide with an α,ω-alkyl diol diacrylate in a molar ratio of 1:1.5 to 1:10 in the presence of a base and a polymerisation inhibitor at temperatures from 70 to 120° C. and unreacted α,ω-alkyl diol diacrylate is separated off, monomers obtainable with the method and their use for manufacturing flame retardant thermoplastic (meth)acrylate polymers and method for manufacturing flame retardant thermoplastic (meth)acrylate polymers with the monomers, polymers obtainable in this way and their use for manufacturing transparent films and panels.

The present invention relates to a method for manufacturing oxaphospha-phenantrene oxide acrylate monomers, the monomers obtainable therewith and their use in manufacturing flame retardant thermoplastic (meth)acrylate polymers, and to a method for manufacturing flame retardant thermoplastic (meth)acrylate polymers with the monomers, polymers obtainable therewith and their use in manufacturing films and panels.

Thermoplastic acrylate and methacrylate polymers (abbreviated (meth)acrylate polymers) are versatile plastics because of their transparency and UV resistance. For example, they can be used as a protective layer in decorative films for coating windows, doors and other components.

A disadvantage of (meth)acrylate polymers is that they are comparatively easily flammable and combustible. To improve this, flame retardants are added. Inorganic flame retardants such as metal hydroxides are poorly suited because transparency suffers at the high loadings required for sufficient effectiveness. Halogen-containing flame retardants are widely used but have come under criticism for toxicological and environmental concerns. Various phosphorus-containing flame retardants have been proposed as halogen-free alternatives. If these are added as low-molecular compounds, the desired flame retardant effect is achieved, but the transparency can suffer and, in addition, migration of the flame retardants is common. This reduces their effect and the surface is altered or, in the case of multilayer films, adhesion to adjacent layers is impaired.

To avoid this, copolymerisable flame retardants are considered optimal. However, it is far from being possible to provide every flame retardant as a comonomer. A particularly effective group of phosphorus flame retardants are phosphinic acid derivatives such as 9,10-dihydro-9-oxa-10-phosphaphenantrene-10-oxide (abbreviated DOPO).

Examples of DOPO and other phosphorus-containing flame retardants are known per se. For example, US 2014/0346418 A1, WO 2015/096127 A1 and US 2017/0029704 A1 describe a flame retardancy by copolymerisation with phosphorus-containing monomers. However, none of the documents mentions DOPO, other organic phosphates are described.

From WO 2008/132111 A1 additives based on DOPO are known, which carry a carboxylic acid group or its ester on the phosphorus. In the case of the preferred polyhydric alcohols for ester formation, additives with several DOPO groups result. However, copolymerisation is not envisaged, the additives are to be admixed with the polymer and only polyamide and polyester are mentioned as the polymer.

WO 2014/124933 A2 describes duromers of DOPO and polyvalent acrylates with at least 3 acrylic groups, which are further reacted with (meth)acrylate. These duromers are said to be suitable as flame retardant additives.

In the article S. Jiang et al, “In situ synthesis of a novel transparent poly (methyl methacrylate) resin . . . ”, DOPO is reacted with formaldehyde and then with acrylic acid chloride to form a monomer and finally copolymerised with methyl methacrylate. The procedure in EP 1 544 227 A1 is analogous: first, DOPO is coupled to an alcohol group, which is then reacted with acrylic acid chloride to form the DOPO acrylate monomer. Acrylic acid chlorides are very reactive substances whose large-scale use is problematic.

The article Wang et al, “Flexible, transparent flame retardant membrane . . . ”, Fire and Materials 2018, vol. 42, pp. 99-108, describes a reaction of methyl ethyl carboxy phosphinic acid with acrylic acid hydroxyethyl ester.

DE 10 2013 223 915 A1, DE 10 2013 101 487 A1 and WO 2019/141572 A1 disclose phosphorus-containing (meth)acrylate monomers for manufacturing flame retardant thermoplastic resin compositions. The phosphorus-containing (meth)acrylate monomer described includes DOPO-oxymethylene methacrylate monomer. The monomer is reacted with one or more at least trivalent (meth)acrylate monomers to form a copolymer, which then forms part of the resin composition as a flame retardant. The polymers in the first two documents are said to be, and are, duromers. According to the latter document, lightly crosslinked or uncrosslinked copolymers are to be obtained by direct copolymerisation with (meth)acrylate monomers by preparing phosphorus-containing triacrylate monomers from approximately equimolar amounts of phosphorus compound and acrylate groups in the triacrylate.

According to JP 2016-060865 A, DOPO acrylate monomers are to be obtained by Michael addition with a DOPO undercut. The document contains long lists of possible (meth)acrylates, among others 1,4-butanediol di(meth)acrylate and 1,6-hexanediol di(meth)acrylate are specifically listed. The aim is to produce crosslinkable coatings in which the refractive index is adjusted with DOPO. Copolymerisation with acrylates is described. However, one of ordinary skill in the art can neither infer from this document that non-crosslinking monomers are producible, nor how this could be achieved.

None of these proposals allows the economical production of transparent, thermoplastic (meth)acrylate polymers with sufficiently effective phosphorus-containing flame retardants as comonomers. Thus, the task remained to provide useful flame retardants for thermoplastic, transparent (meth)acrylate polymers.

Surprisingly, it was now found that starting from DOPO and analogous oxaphosphaphenantrene oxides, useful comonomers can be obtained by Phospha-Michael addition to α,ω-alkyl diol diacrylates, if the α,ω-alkyl diol diacrylate is used in excess and unreacted α,ω-alkyl diol diacrylate is removed, e.g. by vacuum distillation and/or extraction.

The above problem is therefore solved by a method for manufacturing oxaphosphaphenantrene oxide acrylate monomers by Phospha-Michael addition to α,ω-alkyl diol diacrylates having 2 to 6 carbon atoms in the alkyl chain in the presence of a sterically hindered, non-nucleophilic base and a polymerisation inhibitor, wherein the oxaphosphaphenantrene oxide is reacted with the α,ω-alkyl diol diacrylate in a molar ratio of 1:1.5 to 1:10 at temperatures from 70 to 120° C. in the absence of water and unreacted α,ω-alkyl diol diacrylate is separated off, preferably by vacuum distillation. The problem is also solved by the oxaphospha-phenantrene oxide acrylate monomers obtainable therewith, their use for manufacturing (meth)acrylate polymers and a method for manufacturing transparent, thermoplastic (meth)acrylate polymers by copolymerisation of the oxaphosphaphenantrene oxide acrylate monomers with (meth)acrylate monomers.

As previously mentioned, the term (meth)acrylate polymer includes methacrylate polymers and acrylate polymers, as well as copolymers of one or more acrylic acid ester monomer(s) and/or one or more methacrylic acid ester monomer(s). Thus, homopolymers as well as copolymers, terpolymers, etc. are included, wherein the monomers are acrylic acid ester monomers, methacrylic acid ester monomers or both acrylic acid ester and methacrylic acid ester monomers. In a preferred embodiment, the (meth)acrylate polymers contain only (meth)acrylate monomer(s) in addition to the oxaphosphaphenantrene oxide acrylate monomer(s) according to the invention.

Typical acrylic ester monomers are methyl acrylate, ethyl acrylate, n-butyl acrylate, iso-butyl acrylate, tert-butyl acrylate, 2-ethylhexyl acrylate, lauryl acrylate, stearyl acrylate, and benzyl acrylate. Preferred are methyl acrylate, ethyl acrylate, n-butyl acrylate, iso-butyl acrylate, tert-butyl acrylate, and 2-ethylhexyl acrylate, especially ethyl acrylate, n-butyl acrylate, iso-butyl acrylate, and tert-butyl acrylate. Common methacrylic ester monomers are methyl methacrylate, ethyl methacrylate, isopropyl methacrylate, n-butyl methacrylate, iso-butyl methacrylate, tert-butyl methacrylate, neopentyl methacrylate, 2-ethylhexyl methacrylate, lauryl methacrylate, stearyl methacrylate, cyclohexyl methacrylate and benzyl methacrylate. Monomers which are less prone to chain transfer, such as ethyl acrylate, are particularly favourable. Preferred are methyl methacrylate, ethyl methacrylate, n-butyl methacrylate, iso-butyl methacrylate and tert-butyl methacrylate, especially methyl methacrylate. The monomers are also collectively referred to herein as (meth)acrylate monomers.

In principle, acrylic acid and methacrylic acid may also be considered as monomers, but these are not readily miscible with oxaphosphaphenantrene oxides such as DOPO and are therefore preferably not used.

Preferred (meth)acrylate polymers are polymethyl methacrylate (PMMA) and copolymers of methyl methacrylate (MMA) with methyl acrylate (MA), ethyl acrylate (EA), butyl acrylate (BA) and n-butyl methacrylate (BMA).

Furthermore, additional comonomers, such as acrylonitrile, can be polymerised in to further improve desired properties, including fire behaviour.

Oxaphosphaphenantrene oxides are known per se, including the preferred 9,10-dihydro-9-oxa-10-phosphaphenantrene-10-oxide (DOPO), and are commercially available. According to the invention, these are reacted with α,ω-alkyl diol diacrylate to form oxaphosphaphenantrene oxide acrylate monomers, which can then be polymerised as comonomers into (meth)acrylate polymers. Suitable α,ω-alkyl diol diacrylates are those with 2 to 6 carbon atoms in the alkyl chain. An important criterion with regard to the preferred removal of excess α,ω-alkyl diol diacrylate by vacuum distillation is the boiling point; the lower it is, the lower the vacuum or temperature required to remove the unreacted diol diacrylate. In this respect, α,ω-alkyl diol diacrylates with 2 to 4 carbon atoms in the alkyl chain, also branched ones, are preferred, especially ethylene glycol diacrylate and n-butylene glycol diacrylate.

The reaction is carried out at a molar ratio of oxaphosphaphenantrene oxide to α,ω-alkyl diol diacrylate of 1:1.5 to 1:10, preferably 1:3 to 1:7 and especially of about 1:5. The choice of ratio represents a compromise between the effort required in removing the excess α,ω-alkyl diol diacrylate and the selectivity of the reaction. The more α,ω-alkyl diol diacrylate used, the more effort is required to remove the excess (lower space-time yield), but the less dual oxaphospha-phenantrene oxide functionalised acrylate is formed.

The temperature is usually from 70 to 120° C., preferably from 80 to 100° C.

The reaction medium used is either an aprotic solvent with good dissolving power for the phosphaphenantrene oxide or the excess of α,ω-alkyl diol diacrylate. In a preferred embodiment, the reaction is carried out without solvent. This facilitates isolation of the oxaphosphaphenantrene oxide acrylate monomer, which reduces cost. A solvent has the advantage of reducing the risk of premature polymerisation, and solvents may also be easier to distil off. Preferred solvents are toluene, xylenes, ethyl acetate, acetonitrile and tetrahydrofuran, especially toluene and xylenes (o-xylene, p-xylene, m-xylene and mixtures thereof), most preferred toluene. Suitable amounts are, for example, volumes of solvent to the sum of the volumes of reactants and base from 1:5 to 5:1, preferably from 1:2 to 2:1.

Sterically hindered and non-nucleophilic compounds, for example tertiary alkylamines, serve as base, typically in amounts from 0.15 to 2.0 moles per mole of oxaphosphaphenantrene oxide, preferably from 0.5 to 1.2 moles per mole, more preferably from 0.9 to 1.1 moles per mole. The molar ratio of amine to DOPO can be decreased to about 0.15:1; if the amount of amine is decreased still further, the addition becomes much slower and less selective. An excess of base is economically disadvantageous, but has little influence on the reaction. Tertiary alkylamines are particularly suitable as base, with triethylamine being the most suitable in terms of price, boiling point and low toxicity. N-ethyldiisopropylamine and tripropylamine as well as tributylamine are also useful, whereas trimethyl-amine is less suitable because of its very low boiling point. Tertiary aromatic amines such as pyridine are also possible but less preferred. It may be advantageous to add further base after some time of reaction.

A polymerisation inhibitor is added to prevent premature polymerisation of the oxaphosphaphenantrene oxide acrylate and the α,ω-alkyl diol diacrylate. Suitable substances include hydroquinone, phenothiazine, 1-dodecanethiol, hydroquinone monobenzyl ether, methoxyhydroquinone, and other known substances. Hydroquinone and methoxyhydroquinone are preferred. The necessary amounts are known per se. For example, the amount of stabiliser contained in commercial α,ω-alkyl diol diacrylate may suffice.

Since oxaphosphaphenantrene oxides can react with water and base with ring opening, the reaction takes place in the absence of water. Water leads to ring opening and thus to side reactions, i.e. to the formation of the triethylammonium salt of the ring-opened oxaphosphaphenantrene oxide. Absence of water means here a maximum content of less than 1% by weight of water, preferably less than 0.1% by weight of water and particularly preferred less than 0.05% by weight of water in the liquid phase.

Preferably, the reaction takes place under a dry protective gas such as nitrogen. A reaction under air is not recommended for reasons of explosion protection. In addition, triethylamine, for example, is somewhat sensitive to oxidation and the reaction mixture could turn dark in the presence of air. However, small amounts of oxygen are not problematic and may even be beneficial if the most commonly used inhibitor methoxyhydroquinone is used, as this is only active in the presence of traces of oxygen. In this respect, removal of oxygen from the reactants and other components of the reaction solution is not necessary and preferably does not occur.

The reaction is carried out until substantially complete conversion of the oxa-phosphaphenantrene oxide, which typically takes from 1 to 10 hours, often 2 to 5 hours. Hereby, the oxaphosphaphenanthrene oxide is added either in portions or continuously, e.g. with a solid dosage unit, for example over the course of 2.5-3 h. To complete the reaction, the reaction temperature is maintained for 45-60 min after completion of the addition. The addition in portions or continuously is expedient because the addition reaction is moderately exothermic. If for a larger batch all the oxaphosphaphenanthrene oxide is added at the beginning, too much heat of reaction is released in a short time, so that the temperature could rise too high. Furthermore, the addition of oxaphosphaphenanthrene oxide in portions or continuous addition over a longer period of time improves the selectivity; only very little double oxaphosphaphenanthrene oxide functionalised diacrylate is formed.

The reaction product obtained is mainly oxaphosphaphenanthrene oxide acrylate, along with small amounts of di-oxaphosphaphenanthrene oxide acrylate and the excess α,ω-alkyl diol diacrylate. Substantially complete conversion means that at most 5 mol-%, preferably at most 2 mol-%, of the oxaphosphaphenantrene oxide was not reacted. The time to substantially complete conversion can be determined, for example, by ³¹P NMR. Once the time has been determined for specific conditions, no further control is necessary for further conversions. The reaction should be essentially complete, as residues of unreacted oxaphospha-phenantrene oxide are undesirable, but too long a reaction time is of no advantage.

When the reaction is complete, the excess α,ω-alkyl diol diacrylate and, if necessary, the solvent are removed, preferably by vacuum distillation. Alternatively, the excess α,ω-alkyl diol diacrylate and, if necessary, the solvent can also be removed by liquid-liquid extraction. For removal by vacuum distillation, the necessary temperature depends on the available vacuum and the necessary residence time at the high temperature. A thin-film evaporator is most suitable because only very brief heating takes place, which minimises the risk of spontaneous polymerisation. Here, 75-140° C. are suitable. For a longer duration of vacuum distillation, 120° C. should not be exceeded. Preferably, the removal of the excess α,ω-alkyl diol diacrylate is carried out at a pressure of 0.01 to 0.2 mbar, preferably 0.02 to 0.2 mbar. In one embodiment, a liquid-liquid extraction with a hydrocarbon solvent such as cyclohexane is (additionally) carried out to separate the reaction product from the excess α,ω-alkyl diol diacrylate. Other alkanes such as n-hexane, heptane, etc. can also be used, as well as mixtures of alkanes, but cyclohexane was the most efficient of all the solvents tested. The solution of the reaction product is mixed intensively with the hydrocarbon solvent, if necessary before or after distillation, if necessary after addition of solvent, and the separating hydrocarbon solvent phase is removed. This may be repeated a few times, e.g. 2, 3, 4 or 5 times. Vacuum distillation may be carried out before and/or after separation of the α,ω-alkyl diol diacrylate by extraction.

According to the invention, oxaphosphaphenantrene oxide acrylate monomer with a maximum of 3 mol-% diacrylate, in particular with a maximum of 0.5 mol-% diacrylate, is obtained.

The oxaphosphaphenantrene oxide acrylate monomer obtained can be polymerised with (meth)acrylate monomers and optionally further comonomers in a manner known per se, e.g. by means of free-radical emulsion, suspension or substance polymerisation, for manufacturing (meth)acrylate polymers according to the invention. Usually, the monomers are mixed and a radical initiator such as azobis(isobutyronitrile) (AlBN) or benzoyl peroxide is added. Useful proportions of oxaphosphaphenantrene oxide acrylate monomer depend on the desired or necessary flame retardancy and are normally in the range of 10 to 30 mol-%, preferably 20 to 25 mol-% oxaphosphaphenantrene oxide acrylate monomer based on the mixture of all monomers.

To limit the molar mass, additives known per se, such as thiols, can be added during polymerisation. The useful amounts are generally very small and known in the prior art.

The (meth)acrylate polymers according to the invention may contain further additives in a manner known per se, e.g., but not limited to, one or more flame retardants, surface active agents, nucleating agents, coupling agents, fillers, plasticizers, impact enhancers, lubricants, antibacterial agents, release agents, heat stabilizers, antioxidants, light stabilizers, compatibilizers, inorganic additives, antistatic agents, pigments, dyes, etc., and combinations thereof. The additives may be added independently from each other during polymerisation and/or during a pellet forming method (extrusion) to be incorporated into the copolymer. The method for this and the amount added are known per se and are not particularly limited. Typical additive contents are each 0.001 to 10% by weight of additive based on the total mixture, but in the case of fillers up to 50% by weight and more.

In a particularly preferred embodiment, copolymerised phosphorus compounds, which are solid phase active flame retardants, are additionally present to further improve the flame retardant properties of the (meth)acrylate polymer produced according to the invention. These support the effect of the oxaphosphaphenantrene oxide acrylate comonomer active in the gas phase. Phosphorus-containing monomers based on alkyl (meth)acrylate and hydroxyalkyl (meth)acrylate, preferably based on hydroxyethyl (meth)acrylate, are particularly suitable, especially the following:

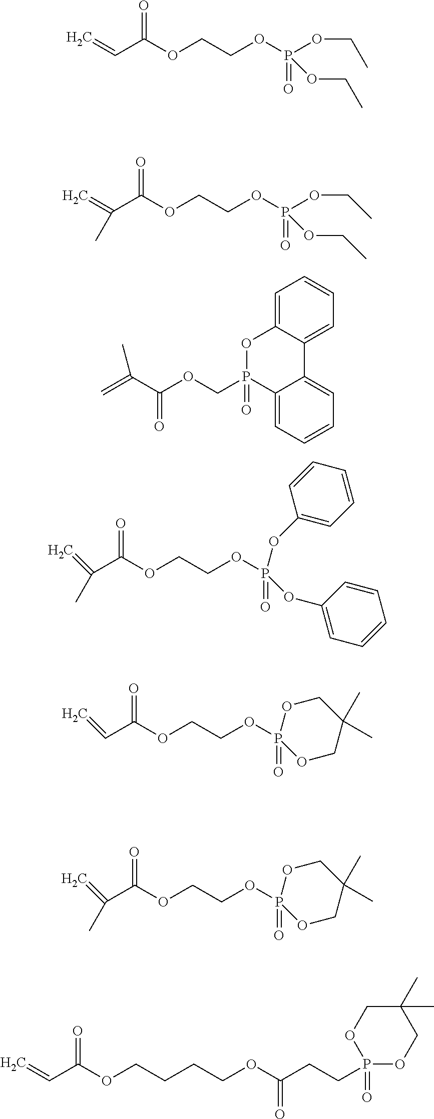

These comonomers are commercially available or can be prepared in a manner known per se. For example, the first compound can be synthesised by reaction of diethyl chlorophosphate with hydroxyethyl acrylate in the presence of an auxiliary base, see e.g. Nair, C. P. Reghunadhan; Clouet, G.; European Polymer Journal (1989), 25(3), 251. The second compound is possible by reaction of diethyl chlorophosphate with hydroxyethyl methacrylate in the presence of the auxiliary base such as triethylamine and copper(I) chloride as catalyst, see CPR Nair, G Clouet, J Brossas; Journal of Polymer Science: Part A: Polymer Chemistry, Vol. 26, 1791-1807 (1988). The fourth compound is prepared by reacting diphenyl chlorophosphate (CAS No. 2524-64-3) with hydroxyethyl methacrylate in the presence of an auxiliary base, see e.g. US 2019/0112457 A1. The fifth and sixth compounds are prepared, for example, by reacting phosphorus oxychloride with neopentyl glycol to give 2-oxo-2-chloro-5,5-di-Me-1,3,2-dioxa-phosphorinane and reacting the latter with hydroxyethyl acrylate and hydroxyethyl methacrylate, respectively, obtainable, see Xing, Weiyi; Song, Lei; Lv, Pin; Jie, Ganxin; Wang, Xin; Lv, Xiaoqi, Hu, Yuan; Materials Chemistry and Physics 123 (2010) 481-486 and CN 104497051 A. The seventh compound is formed by reaction analogously to the method of the invention.

The amounts of solid-phase active phosphorus-containing (meth)acrylate monomer depend on the required flame retardancy and are, for example, in the range from 5 to 30 mol-%, preferably from 10 to 25 mol-%, of phosphorus-containing (meth)acrylate monomer based on the mixture of all monomers. By combining oxaphosphaphenantrene oxide acrylate monomer and a monomer containing a phosphorus compound which is a solid phase active flame retardant, the amount of both comonomers can be reduced so that a total of 10 to 20 mol-% is contained. For example, as little as 3, 4, or 5 to 10 mol-% of the oxaphospha-phenantrene oxide acrylate monomer according to the invention is sufficient. The amount of solid phase active phosphorus-containing (meth)acrylate monomer can be reduced to range from 3 to 20 mol-%, preferably from 5 to 15 mol-%.

Fire behaviour is tested in accordance with regulation UL94 “Tests for Flammability of Plastic Materials for Parts in Devices and Appliances” according to IEC/DIN EN 60695-11-10 and -20 of Underwriters Laboratories. The tests are carried out with an open flame (Bunsen burner). The ignition source has a power of 50 watts (20 mm high flame) and acts on the test specimen twice for 10 s during the V-test and is then removed. The burning time and also the falling off of burning parts are evaluated with the help of a cotton pad, which is located under the test specimen. 5 test specimens (127 mm (5 inches) long and 12.7 mm (0.5 inches) wide, thickness depending on the application) are to be tested. A classification is made if the following requirements are met:

V2: Total burning time of the 10 flame exposures max. 250 s, self-extinguishing within up to 30 seconds at the latest, burning drops are permissible.

V1: total burning time of the 10 flames max. 250 s, self-extinguishing within up to 30 seconds at the latest, burning drops are not permissible, afterglow 60 seconds at most

V0: Total burning time of the 10 flame exposures max. 50 s, self-extinguishing within up to 10 seconds at the latest, burning drops are not permissible, afterglow 30 seconds at most.

The flame retardant, transparent, thermoplastic (meth)acrylate polymers according to the invention usually achieve classifications of V1, often V0.

This makes them particularly suitable for use in layers of decorative films for lamination with components made of metal, wood and plastic, such as window and door frames, fences, façade panels, etc. Such decorative films comprise, for example, a coloured and/or printed base film, e.g. made of PVC or (meth)acrylate polymer. On the underside, the base film may be provided with a primer and/or adhesive, depending on the material of the base film and the material to be laminated with. On the upper side, a protective film made of one or more layers of copolymer according to the invention is applied to protect the base film and, if necessary, the print from UV radiation. Alternatively, the decorative film can also be made of a copolymer according to the invention, or of several layers thereof. In one or more layers of the copolymer according to the invention, polyvinylidene fluoride (PVDF) may be admixed as a non-flammable component. Often, a cover film or lacquer is provided as an outer layer of particularly scratch-resistant and durable plastic such as polytetrafluoroethylene (PTFE), PVDF, etc., which usually also provides protection against soiling at the same time. Such decorative films can be partially or fully coextruded, non-coextruded layers are thermally laminated. The surface can be embossed if, e.g., a wood look is desired. Suitable thicknesses of the decorative film are, for example, from 100 to 300 μm, preferably from 130 or 150 to 200 μm. In this case, the protective layer of copolymer according to the invention accounts for 30 to 40% of the thickness and the cover layer, if present, for 3 to 4% of the thickness. The term “made of a polymer” means that said polymer is the main polymer component of the layer. The presence of one or more other polymers is not excluded, but their amount is usually (in each case) less than 50% by weight, usually less than 30% by weight and often less than 10% by weight based on all polymer components.

Furthermore, the flame retardant transparent thermoplastic (meth)acrylate polymers according to the invention are suitable for the production of transparent and coloured panels. These panels can be used in a variety of applications, e.g. in interior design.

The invention will be explained with reference to the following examples, without, however, being limited to the specifically described embodiments. Unless otherwise indicated or necessary by the context, percentages refer to the weight, in case of doubt to the total weight of the mixture.

The invention also relates to all combinations of preferred embodiments, insofar as these are not mutually exclusive. The indications “approximately” or “about” in connection with a numerical indication mean that at least values higher or lower by 10% or values higher or lower by 5% and in any case values higher or lower by 1% are included.

### EXAMPLES

The oxaphosphaphenantrene oxide acrylate monomers were prepared in three-neck flasks of various capacities equipped with a stirrer, a Claisen attachment with reflux condenser and a nitrogen supply. The temperature was controlled by an oil bath. Before each reaction, the apparatus was dried by heating in a vacuum and filled with nitrogen. For the reaction, the α,ω-alkyl diol diacrylate was filled into the flask with the solvent (toluene) and the base (triethylamine) in a nitrogen countercurrent. Then 9,10-dihydro-9-oxa-10-phosphaphenanthrene-10-oxide (DOPO) was added in portions over several hours. The α,ω-alkyldiol diacrylates used contained methoxyhydroquinone (4-methoxyphenol) as polymerisation inhibitor. In order to keep this active during the reaction, about 20 ml of air was injected at intervals of about 20 minutes. The course of the reaction was followed by taking samples and determining ³¹P NMR spectra.

### Example 1

1,4-Butanediol diacrylate was reacted with DOPO in a molar ratio of 3.5:1. For this purpose, 0.6 mol (118.93 g) of 1,4-butanediol diacrylate and 14.05 g of DOPO were added to the 500 ml three-neck flask filled with nitrogen. Then 80 ml toluene and 0.17 mol (approx. 23.56 ml) triethylamine were added. Subsequently, the mixture was heated under stirring and nitrogen atmosphere to just below its boiling point (approx. 96° C., oil bath temperature approx. 107° C.). At intervals of 60 minutes each, 2 further portions of DOPO were added (11.89 g, 10.81 g, total 36.75 g, 0.17 mol). Stirring was continued for another 60 minutes at unchanged internal temperature (approx. 96° C.). Subsequently, an NMR sample was taken, the NMR indicated a complete reaction.

Toluene and triethylamine were distilled off on a rotary evaporator in vacuo. The residue was subjected to vacuum distillation. At an oil bath temperature of 90° C. and a vacuum of 0.063 mbar, distillation was continued until no more diacrylate condensed in the receiver. Afterwards, the temperature was increased to 125° C. over several steps (vacuum 0.042 mbar). For a further vacuum distillation, the oil bath temperature was slowly increased to 150° C. (vacuum 0.044 mbar). The distillation was stopped because the reaction product started to polymerise.

The obtained reaction product (49.91 g) of formula:

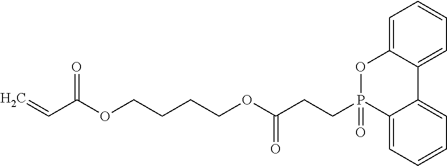 [SMILES: C=CC(=O)OCCCCOC(=O)CCP1(=O)Oc2ccccc2-c2ccccc21]

was then copolymerised with methyl methacrylate in an approximate molar ratio of 1:2.7. For this purpose, the reaction product was dissolved in 200 ml toluene and transferred to a three-neck flask. Then approx. 33.3 g of destabilised methyl methacrylate was added and the solution was heated to 97° C. under nitrogen. Since the solution must not contain oxygen due to the 4-methoxyphenol inhibitor during copolymerisation, stirring was carried out for 1.5 hours at constant temperature under nitrogen. Then, with vigorous stirring, 1 ml of a 0.2 M AlBN solution in toluene was added within 2 minutes and the temperature of the oil bath was raised to 117° C. After 10 minutes, another 1 ml of AlBN solution was added. The reaction solution started to boil strongly. After 25 minutes the solution became more viscous and after 30 minutes a voluminous, gel-like substance precipitated from the solution. The copolymerisation was then continued for 1 hour.

The polymer product obtained was dried for 24 hours at 100° C. in a vacuum drying oven. After drying, the product was slightly rubbery and could not be ground small.

A thermogravimetric analysis (TGA) was carried out. Hereby, the sample was heated in a nitrogen stream at a heating rate of 10 K/min from 35° C. to 800° C. The analysis showed a decomposition temperature of 318° C. with a mass loss of 5%. The polymer product was used to produce a test specimen in a laboratory press at a pressure of 25 bar within 4 minutes. At a temperature of 190° C., it remained very elastic and rubbery. At a temperature of 225° C. and above, the test specimen became firm and brittle, indicating post-crosslinking, i.e. not yet complete polymerisation.

The specimen obtained at 225° C. was examined in a UL94 chamber. In the flame test, the pressed specimen showed a strongly slowed burning behaviour compared to pure PMMA, but did not achieve a V1 classification, as it was not self-extinguishing.

### Example 2

The procedure was the same as in example 1, except that the reaction product was shaken out several times with n-hexane after vacuum distillation (oil bath temperature 140° C., vacuum 0.031 mbar). First 3 times with 50 ml n-hexane each, then after addition of 20 ml toluene 4 times with 40 ml n-hexane each and after addition of further 20 ml toluene again 4 times with 40 ml n-hexane each. The solvents were then removed on the rotary evaporator.

For the copolymerisation, the reaction product (52.82 g) was dissolved in 200 ml toluene and transferred to a three-neck flask. Then approx. 35 g of destabilised methyl methacrylate were added, the solution was heated to 97° C. under nitrogen atmosphere and stirred for 2 hours at constant temperature. Then 1 ml of the 0.2 M AlBN solution was added within 2 minutes under vigorous stirring and the temperature of the oil bath was increased to 117° C. After 14 minutes, 1 ml more of AlBN was added. After 14 minutes, another 1 ml of AlBN was added. The solution started to boil strongly. After 27 minutes the solution became more viscous and after 34 minutes a voluminous gel-like substance precipitated from the solution. The reaction was continued for 1 hour.

The polymer product obtained was dried for 24 hours at 100° C. in a vacuum drying oven. After drying, the product remained slightly rubbery and could not be ground small with a mortar. The TGA analysis showed a similar decomposition temperature as in example 1, 312° C. with a mass loss of 5%. Test specimens were prepared with the product in a laboratory press at a pressure of 25 bar within 4 minutes. At 190° C. the test specimen remained very elastic and rubbery. At a temperature of 225° C. and above, the test specimen became firm and brittle. The specimen showed good transparency. When tested in the UL94 chamber, the specimen pressed for a short time at 225° C. went out directly after the first flame exposure of 10 seconds and after the second it burned for only about 4 seconds, i.e. it achieved a classification V0.

### Comparative Example VB1

The procedure was analogous to example 1, except that butylene glycol dimethacrylate and DOPO were reacted in a molar ratio of 1:1. 0.2 mol (45.25 g) butylene glycol dimethacrylate and 9.24 g DOPO were added to the 500 ml three-neck flask filled with nitrogen. Then 100 ml toluene and 0.12 mol (approx. 16.6 ml) triethylamine were added. Subsequently, the mixture was heated under stirring and nitrogen atmosphere to just below its boiling point (approx. 96° C., oil bath temperature approx. 107° C.). At intervals of 30 minutes, 6 further portions of DOPO were added (8.54 g, 6.99 g, 6.50 g, 4.9 g, 4.00 g, 3.00 g, a total of 43.24 g, 0.2 mol). Stirring was continued for a further 30 minutes at unchanged internal temperature (approx. 96° C.). Subsequently, an NMR sample was taken. The reaction was not yet complete and stirring was continued at the same conditions (approx. 96° C. internal temperature) for 3 hours and then an NMR sample was taken. As the reaction was still not complete, another 5 ml of triethylamine was added and stirring was continued for 1 hour at unchanged conditions. Another NMR sample was taken. DOPO was now completely reacted.

For copolymerisation, the oxaphosphaphenantrene oxide acrylate monomer was first stirred at an internal temperature of about 97° C. for 30 minutes. Then 0.4 mol (40.07 g) of destabilised methyl methacrylate was added in a nitrogen countercurrent. Since the solution must not contain oxygen during copolymerisation due to the 4-methoxyphenol, stirring was continued for another 1.5 hours at constant temperature. Then 2 ml of the 0.2-molar AlBN solution in toluene was added within 2 minutes with vigorous stirring. The solution began to boil strongly and a voluminous gel-like substance precipitated from the solution after a few minutes of reaction time. The temperature of the oil bath was raised to 117° C. and the reaction continued for 1 hour.

The polymer product obtained was dried for 24 hours at 100° C. in a vacuum drying oven and then ground into small pieces. A white powder was obtained. A thermogravimetric analysis (TGA) was then carried out. The analysis showed a decomposition temperature of 255° C. with a mass loss of 5%.

An attempt was made to produce test specimens with the powder in a laboratory press at temperatures of up to 260° C. and pressures of up to 25 bar. However, the powder could not be melted and no test specimen could be produced. A solubility test showed that the polymer obtained could not be dissolved in organic solvents. This shows that no thermoplastic was obtained.

### Comparative Example VB2

Compared to comparative example VB1, the amount of DOPO was slightly increased (45.40 g, 0.21 mol) to reduce the number of unreacted dimethacrylates. In addition, the amount of base and the time between DOPO additions was increased to 60 minutes to ensure a faster conversion of the DOPO. To the 500 ml three-neck flask filled with nitrogen, 0.2 mol (45.25 g) of butylene glycol dimethacrylate and 9.5 g of DOPO were added. Then 100 ml toluene and 0.21 mol (approx. 29.11 ml) triethylamine were added. Subsequently, the mixture was heated to just below its boiling point (approx. 96° C., oil bath temperature approx. 107° C.) under stirring and in a nitrogen atmosphere. At intervals of 60 minutes each, 6 further portions of DOPO were added (8.5 g, 7.5 g, 6.5 g, 5.5 g, 4.5 g, 3.4 g, a total of 45.40 g, 0.21 mol). Stirring was continued for 60 min at unchanged internal temperature (approx. 96° C.). Subsequently, an NMR sample was taken. The reaction was not yet complete. Therefore, stirring was continued for another 2.5 hours at unchanged conditions (approx. 96° C. internal temperature) and another NMR spectrum was recorded. After 3 hours, DOPO was completely consumed according to ³¹P NMR.

The reaction product was copolymerised with methyl methacrylate in a molar ratio of 1:2 after removal of 4-methoxyphenol as in Comparative Example 1. The polymer product obtained was dried for 24 hours at 100° C. in a vacuum drying oven and then ground into small pieces using a ceramic mortar and pestle. The TGA analysis showed a decomposition temperature of 275° C. with a mass loss of 5%. However, as in comparative example VB1, it was not possible to produce a test specimen with the product.

### Comparative Example VB3

Analogous to example 1, ethylene glycol dimethacrylate was reacted with DOPO in a molar ratio of 1.76:1. 0.25 mol (49.60 g) of ethylene glycol dimethacrylate and 8.65 g of DOPO were added to the 500 ml three-neck flask filled with nitrogen. Then 70 ml toluene and 0.10 mol (approx. 13.7 ml) triethylamine were added. Subsequently, the mixture was heated under stirring and nitrogen atmosphere to just below its boiling point (approx. 96° C., oil bath temperature approx. 107° C.). At intervals of 45 minutes each, 4 further portions of DOPO were added (7.57 g, 6.49 g, 5.41 g, 4.32 g, a total of 32.44 g, 0.15 mol). Stirring was continued for a further 60 minutes at unchanged internal temperature (ca. 96° C.). A ³¹P NMR sample revealed traces of unreacted DOPO 1 hour after the last DOPO addition. The reaction mixture was stored overnight and a further NMR sample showed a now essentially complete conversion of the DOPO.

To separate the excess ethylene glycol dimethacrylate, 31 ml n hexane was added. To achieve a better phase separation, the flask was stored in the freezer for 12 hours. Both phases were separated in the separating funnel. Afterwards, 100 ml of n-hexane were added again and the phases were separated again in the separating funnel.

The reaction product was then copolymerised with 36 g methyl methacrylate (molar ratio 1:2). For this purpose, the reaction product as well as 200 ml toluene and 36 g destabilised methyl methacrylate were placed in a three-neck flask and the solution was heated to 97° C. under a nitrogen atmosphere. Since the solution must not contain oxygen, it was stirred for 1.5 hours at a constant temperature. Then, while stirring vigorously, 3 ml of the 0.2 M AlBN solution was added within 5 minutes. The solution began to boil strongly. After 10 minutes, the temperature of the oil bath was increased to 117° C. After 10 minutes, a voluminous gel-like substance precipitated from the solution and the reaction was continued for 1 hour.

The polymer product obtained was dried for 24 hours at 150° C. in a vacuum drying oven and then ground into small pieces. A yellowish-white powder was obtained. The drying temperature may have been too high and the product had partially decomposed. The TGA analysis showed a decomposition temperature of 258° C. with a mass loss of 5%. A test specimen was made with the powder in the laboratory press. This was yellowish, slightly transparent and very brittle, it could not be removed from the mould without breaking. The degree of cross-linking was still too high.

The pieces obtained were examined in a UL94 chamber. In the flame test, the pressed test specimen showed a strongly slowed burning behaviour compared to pure PMMA, but not the desired self-extinguishing after flame exposure.

### Comparative Example VB4

Compared to example 3, the excess of ethylene glycol dimethacrylate was increased to 2.5:1. 0.75 mol (148.6 g) ethylene glycol dimethacrylate and 26 g DOPO were added to the 1 l three-neck flask filled with nitrogen. Then 140 ml toluene and 0.5 mol (approx. 68 ml) triethylamine were added. Subsequently, the mixture was heated under stirring and nitrogen atmosphere to just below its boiling to point (approx. 96° C., oil bath temperature approx. 107° C.). At intervals of 60 minutes, 2 further portions of DOPO were added (21.6 g, 17.3 g, a total of 64.88 g, 0.3 mol). Stirring was continued for 60 minutes at unchanged internal temperature (approx. 96° C.). An NMR sample was then taken, which indicated complete conversion of DOPO.

Triethylamine and toluene were distilled off on the rotary evaporator in vacuo. Next, it was shaken out 3 times with 100 ml n-hexane. Vacuum distillation was then carried out until no dimethacrylate condensed in the receiver at an oil bath temperature of 85° C., a head temperature of 50° C. and a vacuum of 0.05 mbar. The vacuum distillation was repeated twice more, each time at a higher temperature, 95 and 105° C. oil bath temperature. However, the product solution partially polymerised spontaneously. The ¹H NMR showed that dimethacrylates were still present in the reaction product.

The reaction product (119 g) was dissolved in 450 ml toluene and transferred to the three-neck flask. Then approx. 36 g of destabilised methyl methacrylate were added and the solution was heated to 97° C. under nitrogen atmosphere. It was stirred for 1.5 hours at constant temperature. Then, while stirring vigorously, 2 ml of the 0.2 M AlBN solution was added within 4 minutes and the temperature of the oil bath was raised to 117° C. After 10 minutes, another 1 ml of AlBN was added.

The solution started to boil strongly. After 15 minutes, the solution became more viscous. White flakes were visible. After 17 minutes, a voluminous gel-like substance precipitated from the solution and the reaction was continued for 1 hour.

The polymer product obtained was dried for 24 hours at 100° C. in a vacuum drying oven and then ground into small pieces using a ceramic mortar and pestle. The TGA analysis showed a decomposition temperature of 241° C. with a mass loss of 5%. A test specimen was made with the powder in the laboratory press. This was more transparent than in the comparative examples VB1, VB2 and VB3, but still very brittle. It could not be removed from the mould without breaking.

The pieces obtained were tested in a UL94 chamber, the pressed specimen did not show improved fire behaviour compared to VB3.

### Comparative Example VB5

The excess ethylene glycol dimethacrylate was further increased to a molar ratio of 3.5:1. 0.7 mol (138.8 g) of ethylene glycol dimethacrylate and 17.3 g of DOPO were added to the 1 l three-neck flask filled with nitrogen. Then 100 ml toluene and 0.4 mol (approx. 55.5 ml) triethylamine were added. Subsequently, the mixture was heated under stirring and nitrogen atmosphere to just below its boiling point (approx. 96° C., oil bath temperature approx. 107° C.). At intervals of 60 minutes each, 2 further portions of DOPO were added (15.3 g, 10.8 g, total 43.24 g, 0.2 mol). Stirring was continued for 60 minutes at unchanged internal temperature (approx. 96° C.). An NMR sample was then taken, which showed complete conversion of DOPO.

Triethylamine and toluene were distilled off on a rotary evaporator in vacuum and the residue was subjected to vacuum distillation (oil bath temperature 80° C., vacuum 0.04 mbar). During the vacuum distillation, a spontaneous polymerisation of the product occurred when the oil bath temperature was increased to 110° C., it could no longer be stirred.

The examples and comparative examples show that neither with approximately equimolar amounts of reactant nor with an excess of oxaphosphaphenantrene oxide a useful acrylate comonomer is obtained. Only if a sufficient excess of diacrylate is used as provided according to the invention, can a diacrylate reacted only once with oxaphosphaphenantrene oxide be obtained. The excess of α,ω-alkyl diol diacrylate could be separated sufficiently well. In the case of the α,ω-alkyl diol dimethacrylates, however, this is not successful. In particular, comparative examples 1 and 2 show that no thermoplastic (meth)acrylate polymers are obtained with a direct copolymerisation of oxaphosphaphenantrene oxide acrylate monomers with further (meth)acrylate monomers as suggested in WO 2019/141572 A1 and JP 2016-060865 A. In addition to the selection of α,ω-alkyl diol diacrylate and an excess thereof, the separation of the unreacted α,ω-alkyl diol diacrylate as provided according to the invention is also necessary to obtain thermoplastic (meth)acrylate polymers. Table 1 below provides an overview of the examples and comparative examples.

TABLE 1

| | | Molar ratio | | | TGA: decom- | | |
|---|---|---|---|---|---|---|---|
| (comparative) | | diacry- | | Molar ratio | position tem- | fire | thermo- |
| example No. | Diacrylate | late:DOPO | Workup | MMA:Monomer | perature | behaviour | plast? |
| 1 | 1,4 Butanediol- | 3.5:1 | a) vacuum distillation 125° C./0.042 mbar | 2.7:1 | 318° C. | better than | yes |
| | diacrylate | | b) vacuum distillation 150° C./0.044 mbar | | | PMMA | |
| 2 | 1,4 Butanediol- | 3.5:1 | a) vacuum distillation 140° C./0.031 mbar | 2.7:1 | 312° C. | V0 | yes |
| | diacrylate | | b) extraction: 3x 50 ml hexane, | | | | |
| | | | c) +20 ml toluene 4x 40 ml hexane | | | | |
| | | | d) +20 ml toluene 4x 40 ml hexane | | | | |
| VB1 | 1,4 Butanediol- | 1:1 | direct copolymerization | 2:1 | 255° C. | no test | no |
| | dimethacrylate | | | | | specimen | |
| VB2 | 1,4 Butanediol- | 1:1.05 | direct copolymerization | 2:1 | 275° C. | no test | no |
| | dimethacrylate | | | | | specimen | |
| VB3 | 1,2-Ethanediol- | 1.76:1 | a) +70 ml toluene 31 ml hexane | 2:1 | 258° C. | better than | brittle |
| | dimethacrylate | | b) 100 ml hexane | | | PMMA | |
| VB4 | 1,2-Ethanediol- | 2.5:1 | a) +140 ml toluene 3x 100 ml hexane | 2:1 | 241° C. | better than | brittle |
| | dimethacrylate | | b) vacuum distillation 85° C./0.05 mbar | | | PMMA | |
| | | | c) vacuum distillation 95° C./0.05 mbar | | | | |
| | | | d) vacuum distillation 105° C./0.05 mbar | | | | |
| VB5 | 1,2-Ethanediol- | 3.5:1 | polymerized during addition | ./. | ./. | ./. | ./. |
| | dimethacrylate | | | | | | |
| PMMA | | | | | 219° C. | | ja |

### Example 6

Analogous to Example 2, a DOPO acrylate monomer was prepared from DOPO and 1,4-butanediol diacrylate, but with a molar ratio of butanediol diacrylate to DOPO of 7:1. To this end, 1.25 mol (297.3 g) of distilled butanediol diacrylate, 13.6 g of DOPO and 30 mg of 4-methoxyphenol were added to a 250 ml three-neck flask filled with nitrogen. Then 35 ml triethylamine was added by syringe through the septum and the mixture was heated up to 85-87° C. (oil bath temperature) under stirring and nitrogen atmosphere in the course of 20 min. Then a further 9.0 g of DOPO was added. After another 20 min, a third portion of DOPO was added (9.0 g). Three further portions (7.5 g each) were added at intervals of 20 min each. The reaction mixture was stirred for another 30 min at unchanged temperature. Then the heating was turned off. During the Phospha-Michael addition, 20 ml of air were injected at intervals of approx. 15 min. each to keep the inhibitor active.

For the isolation of the DOPO monomer, the obtained product solution was divided into two parts. The product isolation was done for both parts by first distilling off the triethylamine, applying a partial vacuum at the beginning and heating the oil bath to max. 50° C. Then the main part of the excess butanediol diacrylate was distilled (ca. 0.02 mbar), heating up to 105° C. to avoid spontaneous polymerisation. To the distillation residue was added 250 ml of cyclohexane, and then heated rapidly to boiling. After about 5 min of intensive stirring under reflux, the oil bath was removed. The contents of the flask were then cooled to about 40° C. in a water bath, then cooled in a refrigerator, whereupon the supernatant, slightly milky turbid phase was decanted. A further nine extractions were carried out in a similar way (cyclohexane was recovered in each case). Now the extraction residue was heated to 105° C. within 45 min. and the pressure was lowered to approx. 0.02 mbar. These conditions were maintained for approx. 20 min. After cooling, the DOPO monomer was obtained as a slightly turbid, viscous and colourless oil. The ¹H NMR spectrum recorded in deutero-chloroform of the DOPO monomer thus obtained showed good purity. In particular, it showed the successful separation of the excess 1,4-butanediol diacrylate (<1% by weight diacrylate; the amount of doubly DOPO-functionalised product was about 6% by weight).

52.82 g of the DOPO monomer was dissolved in 200 ml toluene for copolymerisation with methyl methacrylate and transferred to a three-neck flask. Then about 35 g of destabilised methyl methacrylate was added, the solution was heated to 97° C. under nitrogen atmosphere and stirred for 2 hours at constant temperature. Then, with vigorous stirring, 1 ml of a 0.2 M AlBN solution was added within 2 minutes and the temperature of the oil bath was increased to 117° C. After 14 minutes, another 1 ml of AlBN was added. The solution started to boil strongly. After 27 minutes the solution became more viscous and after 34 minutes a voluminous gel-like substance precipitated from the solution. The reaction was continued for 1 hour.

The polymer product obtained was dried for 24 hours at 100° C. in a vacuum drying oven. After drying, the product remained slightly rubbery and could not be ground small with a mortar. The TGA analysis showed a similar decomposition temperature as in examples 1 and 2, 312° C. with a mass loss of 5%. Test specimens were made with the product in a laboratory press at a pressure of 25 bar within 4 minutes. At 190° C. the test specimen remained very elastic and rubbery. At a temperature of 225° C. and above, the test specimen became firm and brittle. The specimen showed good transparency. When tested in the UL94 chamber, the specimen pressed for a short time at 225° C. went out directly after the first flame exposure of 10 seconds and after the second flame exposure it burned for only about 4 seconds, i.e. it achieved a classification V0. The results of the fire behaviour test are listed in table 2.

### Example 7

The DOPO monomer of Example 6 was reacted in various amounts with methyl methacrylate and DDPO-HEMA,

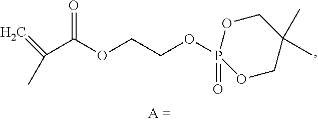 [SMILES: C=C(C)C(=O)OCCOP1(=O)OCC(C)(C)CO1]

both with and without the addition of another monomer, such as methyl acrylate or n-butyl methacrylate, to form a methyl acrylate polymer. A suspension polymerisation was carried out in water with 1-decylthiol as regulator and dibenzoyl peroxide (BPO) as initiator. The liquid monomers were destabilised before polymerisation; DDPO-HEMA (A) was recrystallised from tert-butyl methyl ether (melting point 50.5° C.). The syntheses of the methacrylate polymers were carried out in a reaction apparatus consisting of a 250 ml three-neck flask, magnetic stirrer, heating bath, a dropping funnel and a reflux condenser on which a three-way tap with bubble counter was mounted. Both the dropping funnel and the three-way tap on the reflux condenser were connected with a Schlenk line.

From the methacrylate polymers obtained, compact transparent test rods as well as transparent films of different thickness were produced with an oil-hydraulic laboratory press of the type HB 20 300 (Schmidt Maschinentechnik; Bretten-Bauerbach, Germany). The test bars had the following dimensions: 70 mm×10 mm×0.8 mm. Temperatures of 210-245° C. were applied during pressing (depending on the melting behaviour of the methacrylate polymers). The quantities and results of the fire behaviour test are listed in table 2.

### Example 7a

For copolymerisation, a mixture of 1.35 g DDPO-HEMA (A), 1.35 g DOPO monomer, 7.3 g methyl methacrylate, 34 mg 1-decyl mercaptan and 67 mg water-bearing BPO was added to the dropping funnel. Vacuum was then applied twice briefly and nitrogen was allowed to flow in again each time. To remove the oxygen, the mixture of water and 1.3 ml of a 2% solution of the suspension stabiliser Kuraray Poval 25-88 (partially hydrolysed polyvinyl alcohol) was stirred for 30 min at 85-90° C., with a moderate flow of nitrogen through the three-way stopcock into the apparatus and to the bubble counter. After the aqueous solution had cooled to about 62° C., the solution from the dropping funnel was added. Then the contents of the flask were heated to 73° C. within 20 min. with stirring. A milky emulsion was formed. The connection to the bubble counter was shut off 10 min after the monomer addition. Now the temperature was increased by 1° C. at intervals of approx. 15 min. each until a temperature of 82° C. was reached. Stirring was continued vigorously for four hours. After that, a solution of 65 mg BPO and 500 mg methyl methacrylate was added and the temperature was increased to 87° C. At this temperature, the reaction mixture was stirred for 12 h under a nitrogen atmosphere. Spheres were formed, as well as some compact material. The supernatant aqueous solution was decanted, then water was added and sucked off through a paper filter. The methacrylate polymer was dried for 5 h at 80° C. and for one hour at 100° C. in vacuum (approx. 0.02 mbar). The ³¹P NMR spectrum of this polymer recorded in deutero-chloro form contained only the signals of the DOPO unit (approx. 36 ppm) and the DDPO unit (−8.2 ppm). The ratio of the signal integrals was nearly the expected value of 1.00:1.50. Approximately 9 g of the methacrylate polymer was obtained.

### Example 7b

For the copolymerisation, 65 ml of deionised water and 1.3 ml of a 2% by weight aqueous solution of Kuraray Poval 25-88 KL (suspension stabiliser, partially hydrolysed polyvinyl alcohol) were added to the three-necked flask. A solution consisting of 1.7 g of DDPO-HEMA (A), 1.5 g of the DOPO monomer, 6.0 g of methyl methacrylate, 0.8 g of methyl acrylate, 45 mg of 1-decyl thiol and 80 mg of water-bearing BPO (60 mg of pure BPO) was added to the dropping funnel. The dropping funnel was partially evacuated twice and refilled with nitrogen to remove the atmospheric oxygen from the reagent mixture. The reaction flask containing the aqueous solution was also partially evacuated twice and each time filled again with nitrogen. Then the contents of the flask were heated to 95° C. with stirring, and a moderate flow of nitrogen was passed through the three-way stopcock into the apparatus and to the bubble counter. After 30 min. of stirring, the temperature was lowered to approx. 65° C. The contents of the dropping funnel were added to the aqueous solution thus freed from oxygen. Then the contents of the flask were heated to 73° C. within approx. 20 min. in a weak nitrogen stream with stirring. Over the course of two hours, the temperature was increased to 83° C. A moderate nitrogen flow continued to be directed to the bubble counter. After another hour, a solution of approximately 35 mg of water-bearing BPO in 0.37 g of methyl methacrylate was added through the dropping funnel. Subsequently, the temperature of the heating bath was increased to 87° C. After a further 30 min, the bubble counter was disconnected. Stirring at 87° C. was continued for 12 h. Then the aqueous phase was decanted. A methacrylate polymer was obtained as compact pieces and film-like material. This polymer was soluble in chloroform and dimethyl sulphoxide. To remove monomer residues as well as water, the polymer was heated in vacuum (approx. 0.02 mbar) first to 90° C. for 3 h and then to 105° C. for 45 min. In the ³¹P NMR spectrum of the methacrylate polymer thus obtained, the signals of the DOPO unit and the DDPO unit were present at about 36 ppm and about −8 ppm, respectively, and the intergral ratio was close to the expected value.

### Example 7c

For copolymerisation, 55 ml of deionised water and 1.5 ml of a 2% by weight aqueous solution of Kuraray Poval 25-88 KL (suspension stabiliser, partially hydrolysed polyvinyl alcohol) were added to the three-neck flask. Then a solution of 1.9 g of DDPO-HEMA, 1.7 g of the DOPO monomer, 5.4 g of methyl methacrylate, 1.0 g of methyl acrylate, 25 mg of 1-decylthiol and 90 mg of water-bearing BPO (corresponding to 67 mg of pure BPO) was added to the dropping funnel. The dropping funnel was partially evacuated twice and refilled with nitrogen to remove the atmospheric oxygen from the reagent mixture. The reaction flask containing the aqueous solution was also partially evacuated twice and each time filled again with nitrogen. Then the contents of the flask were heated to 95° C. while stirring, and a moderate flow of nitrogen was passed through the three-way stopcock into the apparatus and to the bubble counter. After 30 min of stirring, the temperature was lowered to about 65° C. The contents of the dropping funnel were added to the aqueous solution thus freed from oxygen. Then the temperature of the oil bath was raised to 75° C. while vigorously stirring the reaction mixture, producing a milky-white suspension. Stirring was continued for 3.5 h, gradually increasing the temperature of the heating bath to 84° C. Then a solution of 35 mg BPO, 0.33 g methyl methacrylate and 0.07 g methyl acrylate was added in nitrogen countercurrent through the dropping funnel. Subsequently, the temperature of the heating bath was increased to 87° C. After another hour, the connection to the bubble counter was interrupted and the cooling water was turned off. The reaction mixture was stirred for another 12 h under these conditions. Then the aqueous solution was decanted from the methacrylate polymer, which had formed partly as spheres and partly as a compact or film-like material. The methacrylate polymer was washed three times with water and dried on filter paper. The ^{1H} NMR spectrum of the polymer recorded in deutero-chloroform showed that unreacted monomers were present. Therefore, the polymer was heated in a fine vacuum (approx. 0.02 mbar) first to approx. 87° C. (4 h) and then to 93° C. (1 h). Afterwards, the ¹H NMR spectrum of the methacrylate polymer showed the almost complete disappearance of the acrylate/methacrylate groups. In the ³¹P NMR spectrum, the signals of the DOPO unit and the DDPO unit were present at about 36 ppm and about −8 ppm, respectively, with an intergral ratio close to the expected value of 1.00:1.66.

### Example 7d

For copolymerisation, 60 ml of deionised water and 2.0 ml of a 2% by weight aqueous solution of Kuraray Poval 25-88 KL (suspension stabiliser, partially hydrolysed polyvinyl alcohol) were added to the three-neck flask. Then a solution of 2.22 g of DDPO-HEMA, 1.8 g of the DOPO monomer, 7.08 g of methyl methacrylate, 0.9 g of butyl methacrylate, 35 mg of 1-decylthiol and 108 mg of water-bearing BPO (corresponding to 81 mg of pure BPO) was added to the dropping funnel. The dropping funnel was partially evacuated twice and refilled with nitrogen to remove the atmospheric oxygen from the reagent mixture. The reaction flask containing the aqueous solution was also partially evacuated twice and each time filled again with nitrogen. Then the contents of the flask were heated to 95° C. with stirring, and a moderate flow of nitrogen was passed through the three-way stopcock into the apparatus and to the bubble counter. After 60 min. of stirring, the temperature was lowered to about 63° C. The contents of the dropping funnel were added to the aqueous solution thus freed from oxygen. The temperature of the heating bath was then increased to 75° C. This temperature was maintained for 20 min; then the set temperature was increased to 77° C. and 30 min later to 80° C. This temperature was maintained for 50 min. Then the set temperature was increased to 85° C. A milky emulsion had formed. Stirring was very intensive for three hours and a stream of nitrogen continued to be fed into the apparatus and to the bubble counter. The formation of polymer could be seen. Afterwards, the connection to the bubble counter was interrupted, the cooling water was turned off and stirring was continued for another 12 h at 85° C. under slight nitrogen counterpressure. Then the aqueous solution was decanted from the methacrylate polymer, which had formed partly as small spheres and partly as compact material. The methacrylate polymer was washed three times with water and dried on filter paper. The NMR spectra of the polymer obtained in this way showed about 95% conversion of the acrylate and methacrylate groups. The polymer was dried in vacuum (0.02 mbar) for three hours at 87-95° C. to remove water residues. The ¹H NMR spectrum of the methacrylate polymer showed the almost complete disappearance of the acrylate/methacrylate groups. In the ³¹P NMR spectrum, the signals of the DOPO unit and the DDPO unit were present at about 36 ppm and about −8 ppm, respectively, with an intergral ratio close to the expected value of 1.00:2.33. The methacrylate polymer thus obtained was readily soluble in organic solvents such as chloroform. It softened at about 160° C. and melted at about 200° C.

### Example 8

The DOPO monomer of example 6 was reacted in various amounts with methyl methacrylate and DEPO-HEMA,

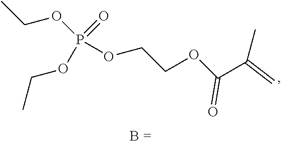 [SMILES: C=C(C)C(=O)OCCOP(=O)(OCC)OCC]

both with and without the addition of another monomer, such as methyl acrylate or n-butyl methacrylate, to form a methyl acrylate polymer. A suspension polymerisation was carried out in water with 1-decylthiol as regulator and dibenzoyl peroxide (BPO) as initiator. The monomers were destabilised before polymerisation. The syntheses of the methacrylate polymers were carried out in a reaction apparatus consisting of a 250 ml three-neck flask, magnetic stirrer, heating bath, a dropping funnel and a reflux condenser on which a three-way tap with bubble counter was mounted. Both the dropping funnel and the three-way valve on the reflux condenser were connected with a Schlenk line.

Compact test bars and films of different thicknesses were produced from the methacrylate polymers obtained using an oil-hydraulic laboratory press of the type HB 20 300 (Schmidt Maschinentechnik; Bretten-Bauerbach, Germany). The test bars had the following dimensions: 70 mm×10 mm×0.8 mm. Temperatures of 220-245° C. were applied during pressing (depending on the melting behaviour of the methacrylate polymers). The quantities and results of the fire behaviour test are listed in table 2.

### Example 8a

The polymerisation was carried out analogously to example 7c. Most of the methacrylate polymer was obtained in compact pieces, which were detached from the glass wall and washed with water. The ^{1H} NMR spectrum of this polymer, recorded in deutero-chloroform, showed that unreacted monomers were present. Therefore, the polymer was heated in a fine vacuum (approx. 0.02 mbar) first to approx. 87° C. (4 h) and then to 93° C. (1 h). Afterwards, the ^{1H} NMR spectrum of the methacrylate polymer showed the almost complete disappearance of the acrylate/methacrylate groups. In the ³¹P NMR spectrum, the signals of the DOPO moiety and the diethyl phosphate moiety were present at about 36 ppm and 1.3 ppm, respectively, with an intergral ratio close to the expected value of 1.00:1.74.

### Example 8b

The polymerisation was carried out analogously to example 7c. The methacrylate polymer was obtained as relatively large polymer beads (granules) which were washed twice with water. The polymer was dried for 5 h in vacuum (0.02 mbar) at 87-105° C. and then analysed by NMR spectroscopy. The ¹H NMR spectrum of the methacrylate polymer showed the complete disappearance of the acrylate/methacrylate groups. The ³¹P NMR spectrum was also as expected: the signals of the DOPO unit and the diethyl phosphate unit were present at about 36 ppm and −1.3 ppm, respectively, with an intergral ratio close to the expected value of 1.00:1.74.

### Comparative Example VB8a

The polymerisation was carried out analogously to Example 7c. The methacrylate polymer was obtained in compact pieces, which were detached from the glass wall, and washed with water. The ¹H NMR spectrum of this polymer recorded in deutero-chloroform showed a relatively high proportion of unreacted monomers. The polymer was heated in a fine vacuum (approx. 0.02 mbar) first to approx. 87° C. (3 h) and then to 97° C. (1 h). Afterwards, the ¹H NMR spectrum of the methacrylate polymer showed the almost complete disappearance of the acrylate/methacrylate groups. The methacrylate polymer thus obtained had a phosphorus content of about 4% by weight.

TABLE 2

| (compar- | | | | | | | |
|---|---|---|---|---|---|---|---|
| ative) | DOPO- | | | | | | mass |
| example | Monomer | A or B | MMA | MA | BMA | | fraction |
| No. | [mol-%] | [mol-%] | [mol-%] | [mol-%] | [mol-%] | fire behaviour | P |
| 6 | 26.7 | — | 73.3 | — | — | V0, specimen | 2.2% |
| | | | | | | self-extinguishing | |
| 7a | 4.0 | A 6.0 | 90.0 | — | — | Burns slowly, not | 2.5% |
| | | | | | | self-extinguishing | |
| 7b | 4.6 | A 7.7 | 75.9 | 11.8 | — | better than 6a | 3% |
| 7c | 5.4 | A 8.9 | 70.5 | 15.2 | — | Film & specimen | 3.4% |
| | | | | | | self-extinguishing | |
| 7d | 3.9 | A 11.8 | 77.4 | — | 6.9 | Specimen burns | 3% |
| | | | | | | slowly, film | |
| | | | | | | (approx. 0.2 mm) | |
| | | | | | | self-extinguishing | |
| 8a | 5.3 | B 9.3 | 70.2 | 15.1 | — | with prolonged | 3.5% |
| | | | | | | second flaming, | |
| | | | | | | specimen | |
| | | | | | | continues to burn | |
| 8b | 5.7 | B 10.0 | 72.6 | — | 11.8 | Slightly worse | 3.5% |
| | | | | | | than 7a | |
| VB8a | — | B 11.4 | 74.4 | 14.2 | — | Specimen ignites | 4% |
| | | | | | | after prolonged | |
| | | | | | | flame exposure, | |
| | | | | | | continues to burn | |
| | | | | | | slowly; 0.4 mm | |
| | | | | | | film self- | |
| | | | | | | extinguishing | |
| | | | | | | Worse than 7a, | |
| | | | | | | slightly worse | |
| | | | | | | than 7b | |

These examples show that the combination of the oxa-phosphaphenantrene oxide acrylate monomer according to the invention with a copolymerised, solid-phase active phosphorus compound offers an optimal flame retardant effect. The solid-phase active phosphorus compound alone is not sufficiently effective. This is shown by the methacrylate polymer of Comparative Example 8a, whose flame retardant effect was worse than that of Examples 7c, 8a and 8b, despite a higher phosphorus content.

1-18. (canceled)

19. Method for manufacturing oxaphosphaphenantrene oxide acrylate monomers by Phospha-Michael addition to α,ω-alkyl diol diacrylates having 2 to 6 carbon atoms in the alkyl chain,
wherein
the oxaphosphaphenantrene oxide is reacted with the α,ω-alkyl diol diacrylate in a molar ratio of 1:1.5 to 1:10 in the presence of a base and a polymerisation inhibitor, at temperatures from 70 to 120° C. and in the absence of water, and unreacted diol diacrylate is separated off.

20. Method according to claim 19, wherein the oxaphosphaphenantrene oxide is 9,10-dihydro-9-oxa-10-phosphaphenantrene-10-oxide.

21. Method according to claim 19, wherein the separation of unreacted diol diacrylate is carried out by vacuum distillation and/or liquid-liquid extraction with a hydrocarbon solvent.

22. Method according to claim 21, wherein the hydrocarbon solvent is n-pentane, n-hexane, n-heptane or a mixture of two or all of them.

23. Method according to claim 19, wherein the Phospha-Michael addition is carried out in toluene, o-xylene, m-xylene, p-xylene or mixtures of two or more thereof as solvent.

24. Method according to claim 19, wherein a sterically hindered tertiary amine is used as base.

25. Method according to claim 19, wherein the base is used in an amount of from 0.15 to 2.0 mol per mol of oxaphospha-phenantrene oxide.

26. Method according to claim 19, wherein the α,ω-alkyl diol diacrylates has 2 to 4 carbon atoms in the alkyl chain.

27. Oxaphosphaphenantrene oxide acrylate monomer obtained by a method according to claim 19.

28. Oxaphosphaphenantrene oxide acrylate monomer according to claim 27, wherein a maximum of 3 mol-% diol diacrylate is present.

29. Method for manufacturing flame retardant, thermoplastic (meth)acrylate polymers by copolymerisation of at least one (meth)acrylate monomer with a phosphorus-containing acrylate monomer,
wherein the phosphorus-containing acrylate monomer used is oxaphosphaphenantrene oxide acrylate monomer obtained according to claim 19.

30. The method according to claim 29, wherein the (meth)acrylate monomers are selected from the group consisting of ethyl acrylate, n-butyl acrylate, iso-butyl acrylate, tert-butyl acrylate, methyl methacrylate, ethyl methacrylate, n-butyl methacrylate, iso-butymethacrylate, tert-butymethacrylate and mixtures thereof.

31. Method according to claim 29, wherein additionally copolymerized phosphorus compounds active in the solid phase are polymerized in.

32. Film or panel produced from a flame retardant, thermoplastic (meth)acrylate polymer obtained according to claim 29.

33. Film or panel according to claim 32, wherein the films or panels are transparent.

34. Film according to claim 32, wherein the film is a decorative film comprising a layer containing the (meth)acrylate polymer.

35. Method according to claim 24, wherein the separation of unreacted diol diacrylate is carried out by vacuum distillation or by vacuum distillation and liquid-liquid extraction with a hydrocarbon solvent before and/or after vacuum distillation.

36. Method according to claim 35 wherein the solvent is selected from the group consisting of n-pentane, n-hexane, and n-heptane.

37. Method according to claim 35, wherein the base is used in an amount from 0.9 to 1.1 mol per mol of oxaphosphaphenantrene oxide.

38. Method according to claim 35, wherein the α,ω-alkyl diol diacrylate is ethylene glycol diacrylate or n-butylene glycol diacrylate.

39. Method according to claim 37, wherein the α,ω-alkyl diol diacrylate is ethylene glycol diacrylate or n-butylene glycol diacrylate.

40. Method according to claim 31, wherein the copolymerized phosphorus compounds active in the solid phase selected from 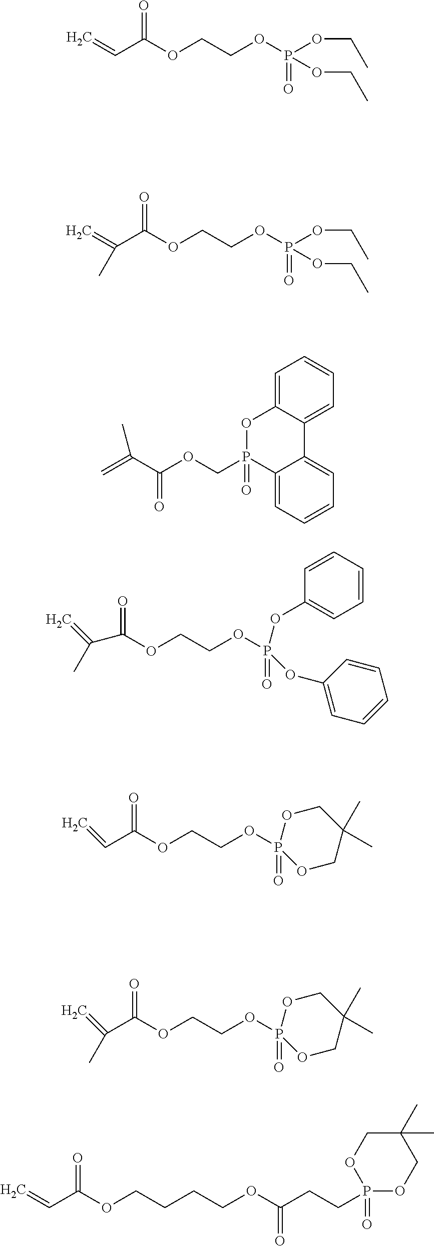
and mixtures of two or more thereof.

41. Film or panel according to claim 32, wherein additionally copolymerized phosphorus compounds active in the solid phase are polymerized in into the flame retardant, thermoplastic (meth)acrylate polymer, and the phosphorus compounds are phosphorus-containing monomers based on alkyl acrylate or hydroxyalkyl (meth)acrylate.

42. Film or panel according to claim 32, wherein additionally copolymerized phosphorus compounds active in the solid phase are polymerized in into the flame retardant, thermoplastic (meth)acrylate polymer, and the phosphorus compounds are selected from 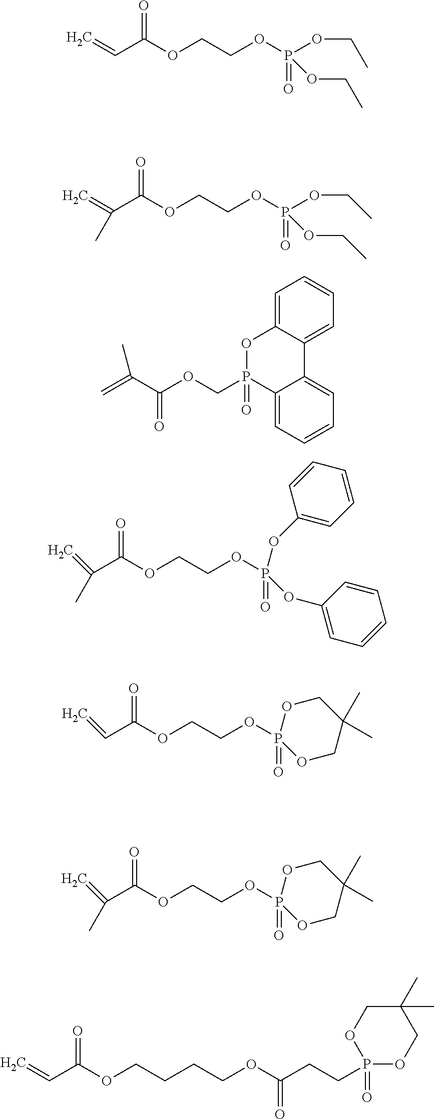
and mixtures of two or more thereof.
